(19) United States
(12) Patent Application Publication
(10) Pub. No.: US 2026/0066481 A1
(43) Pub. Date: Mar. 5, 2026

(54) OVERMOLDED COMPONENT OF TRACTION BATTERY PACK

(71) Applicant: Ford Global Technologies, LLC, Dearborn, MI (US)

(72) Inventors: Francisco Fernandez - Galindo, Canton, MI (US); Alexey Konstantinov, Dearborn, MI (US); Daniel Paul Roberts, Livonia, MI (US)

(21) Appl. No.: 18/822,609

(22) Filed: Sep. 3, 2024

(51) Int. Cl. H01M 50/519; H01M 50/227; H01M 50/262; H01M 50/507

(52) U.S. Cl. CPC H01M 50/519; H01M 50/227; H01M 50/262; H01M 50/507

(57) ABSTRACT

A traction battery pack assembly includes a frame; one or more busbars secured to the frame; a circuit board; and an overmolded covering that secures the circuit board to the frame. A traction battery pack circuit board securing method includes positioning a circuit board adjacent a frame. The frame is configured to hold a plurality of busbars of a traction battery pack. The method further includes overmolding the circuit board with a covering to secure the circuit board relative to the frame.

### TECHNICAL FIELD

This disclosure relates generally to securing a component within a traction battery pack and, more particularly, to securing the component using an overmolded covering.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

In some aspects, the techniques described herein relate to a traction battery pack assembly, including: a frame; one or more busbars secured to the frame; a circuit board; and an overmolded covering that secures the circuit board to the frame.

In some aspects, the techniques described herein relate to a traction battery pack assembly, wherein the overmolded covering and the circuit board are disposed with a cavity of the frame.

In some aspects, the techniques described herein relate to a traction battery pack assembly, further including a cell stack having a plurality of terminals that each extend through a respective slot in the frame.

In some aspects, the techniques described herein relate to a traction battery pack assembly, wherein the circuit board and the overmolded covering are sandwiched between the cell stack and the frame.

In some aspects, the techniques described herein relate to a traction battery pack assembly, wherein the frame is a polymer-based material.

In some aspects, the techniques described herein relate to a traction battery pack assembly, wherein the busbars are secured to the frame with a plurality of heat stakes.

In some aspects, the techniques described herein relate to a traction battery pack assembly, further including at least one sense lead trace of the circuit board, the one or more busbars electrically coupled to the at least one sense lead trace.

In some aspects, the techniques described herein relate to a traction battery pack assembly, wherein the one or more busbars include at least one tab that extends through a slot in the frame to contact the at least one sense lead trace.

In some aspects, the techniques described herein relate to a traction battery pack assembly, wherein the one or more busbars are on a first side of the frame, and the overmolded covering is on an opposite, second side of the frame.

In some aspects, the techniques described herein relate to a traction battery pack assembly, further including an electrical connector disposed on the first side of the frame and extending through the frame to operatively connect to the circuit board.

In some aspects, the techniques described herein relate to a traction battery pack assembly, wherein the overmolded covering is an low-pressure overmolded covering.

In some aspects, the techniques described herein relate to a traction battery pack assembly, wherein the circuit board is a printed circuit board.

In some aspects, the techniques described herein relate to a traction battery pack assembly, further including one or more wires secured to the frame by the overmolded covering.

In some aspects, the techniques described herein relate to a traction battery pack assembly, including: a frame; one or more busbars secured to the frame; one or more wires; and an overmolded covering that secures the one or more wires to the frame.

In some aspects, the techniques described herein relate to a traction battery pack circuit board securing method, including: positioning a circuit board adjacent a frame, the frame configured to hold a plurality of busbars of a traction battery pack; and overmolding the circuit board with a covering to secure the circuit board relative to the frame.

In some aspects, the techniques described herein relate to a traction battery pack circuit board securing method, wherein the overmolding is a low-pressure overmolding.

In some aspects, the techniques described herein relate to a traction battery pack circuit board securing method, further including, during the overmolding, injecting material over the circuit board at a pressure that is from 50 to 200 pounds per square inch.

In some aspects, the techniques described herein relate to a traction battery pack circuit board securing method, further including, during the overmolding, injecting material over the circuit board while the circuit board is held within a cavity provided by the frame.

In some aspects, the techniques described herein relate to a traction battery pack circuit board securing method, further including a plurality of busbars secured to the frame and extending through the frame to connect to the circuit board.

In some aspects, the techniques described herein relate to a traction battery pack circuit board securing method, wherein the plurality of busbars are secured to a first side of the frame, and the circuit board is overmolded to an opposite, second side of the frame.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a perspective view of a battery cell from the battery pack of FIG. 2.

FIG. 4 illustrates a frame of a crossmember assembly from the battery pack of FIG. 3.

FIG. 5 illustrates the frame of FIG. 4 with a circuit board disposed within a cavity of the frame.

FIG. 6 illustrates an area of FIG. 5 with the frame and removed to show how the circuit board couples to an electrical connector and a busbar of the crossmember assembly.

FIG. 7 illustrates the frame of FIG. 5 with an overmolded covering securing the circuit board in the cavity of the frame.

### DETAILED DESCRIPTION

This disclosure details exemplary assemblies of a traction battery pack having a circuit board secured with an overmolded covering. The circuit board can be disposed within a cavity provided by a frame of a crossmember assembly.

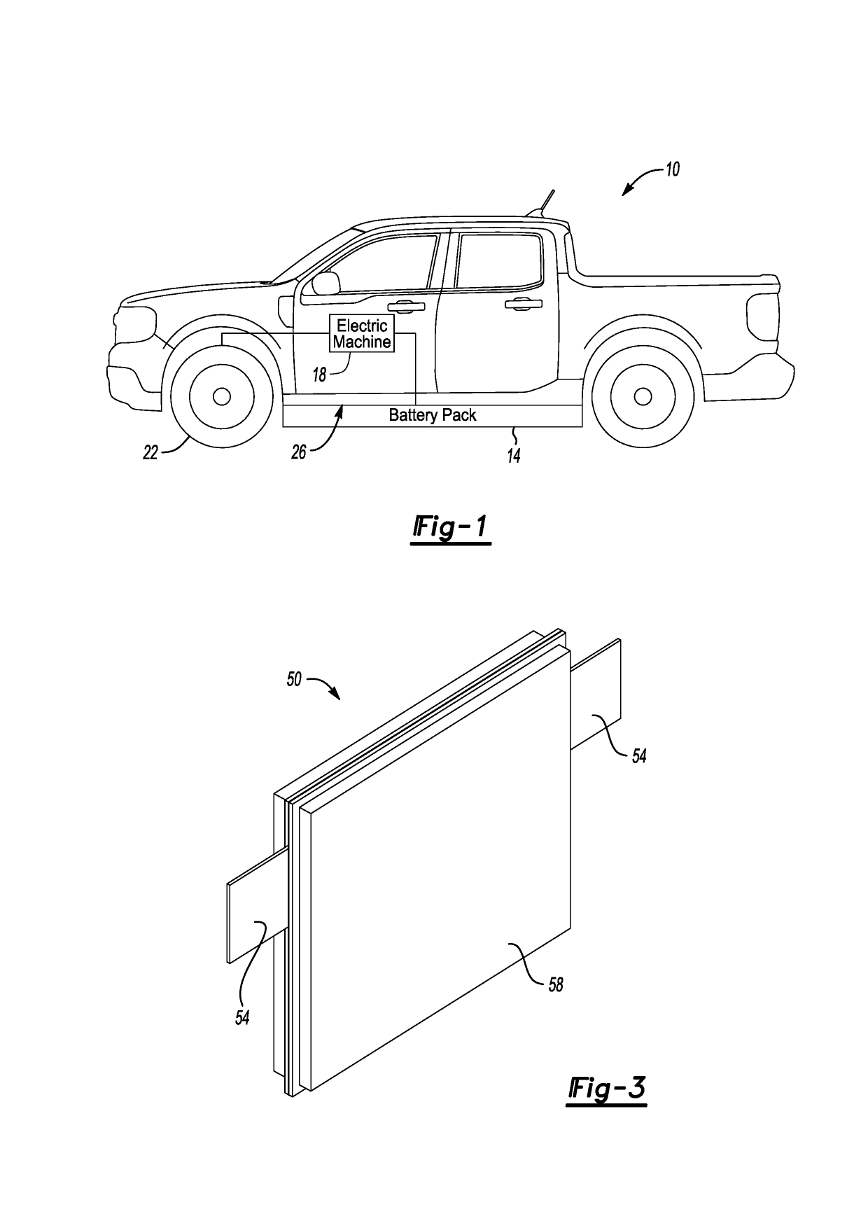

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

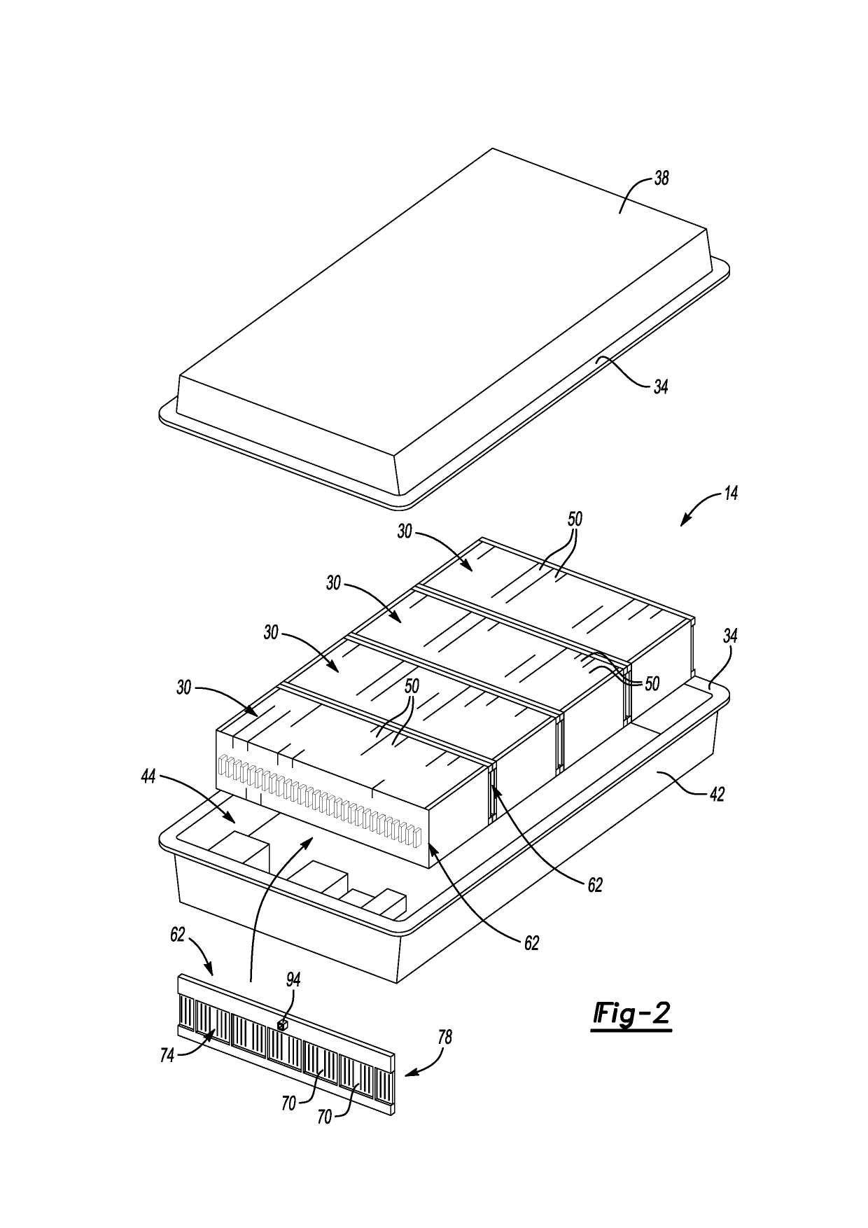

With reference now to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) stacked side-by-side relative to each along a respective cell stack axis. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

With the cell stacks 30, the individual battery cells 50 can be electrically connected together. The cell stacks 30 can also be connected to each other. To facilitate these electrical connections, the battery cells 50 each include a pair of tab terminals 54 extending from a case 58. The tab terminals 54 of the battery cells 50 can be connected to the tab terminals 54 of other battery cells 50 and to other structures.

The tab terminals 54 are typically thin strips of foil. The tab terminals 54 can be, for example, copper foil or aluminum foil.

In this example, alongside the battery cells 50 of the cell stacks 30 are crossmember assemblies 62. The battery cells 50 of each example cell stack 30 are positioned between two crossmember assemblies 62.

The crossmember assemblies 62 each include a frame 66, and one or more busbars 70 secured to a first side 74 of the frame 66. An opposite second, side 78 of the frame 66 faces the battery cells 50. Heat stakes hold the busbars 70 to the frame 66 in this example. The frame 66 can be a polymer-based material. The frame 66 can be injection molded.

The frame 66 includes a plurality of slots 82. When the crossmember assemblies 62 are installed, the tab terminals 54 extend through the slots 82 from the second side 78 of the frame 66 to the first side 74 of the frame 66. The tab terminals 54 can be folded over the busbars 70 and secured to the busbars 70 via, for example, welds. This electrically connects the battery cells 50 the busbars 70.

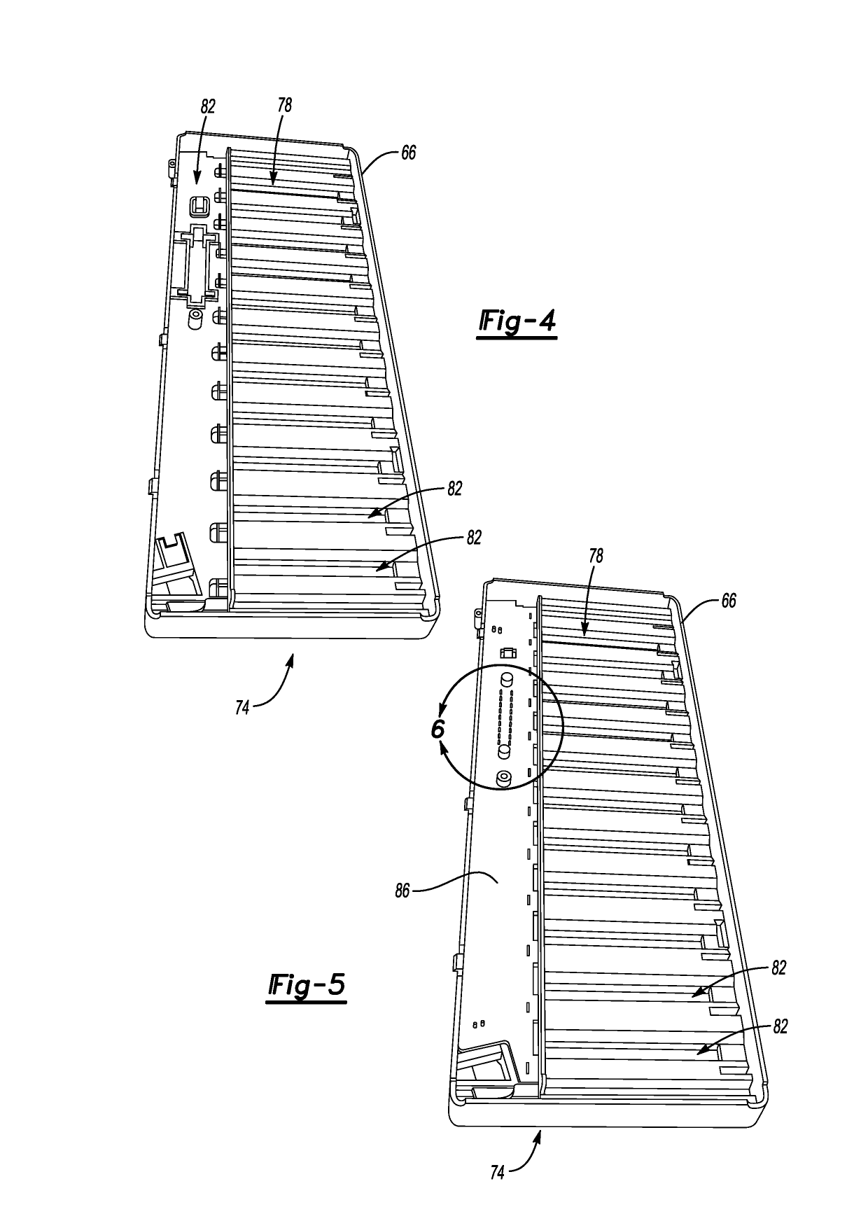

The crossmember assemblies 62 include additional components. In particular, with reference now to FIGS. 4–7 and continued reference to FIG. 2, the crossmember assemblies 62 each include a circuit board 86, an overmolded covering 90, and, optionally, an electrical connector 94.

The circuit boards 86 are disposed within a cavity 98 within the second side 78 of the frame 66. The overmolded covering 90 secures the circuit board 86 within the respective cavity 98. In another example, one or more wires, such as wires within flat flexible cable could be secured to the frame 66 with the overmolded covering 90. The one or more wires can be secured to the frame 66 instead of, or in addition to, the circuit board 86.

To assemble the circuit board 86, the frame 66 can be positioned as shown in FIG. 4 with the cavity 98 facing vertically upward. Next, the circuit board 86 is positioned adjacent to the frame 66 within the cavity 98. When the circuit board 86 is within the cavity 98, the electrical connector 94 can extend from the first side 74 of the frame 66 through the frame 66 and electrically couple to the circuit board 86. The electrical connector 94 is a low voltage electrical connector in this example.

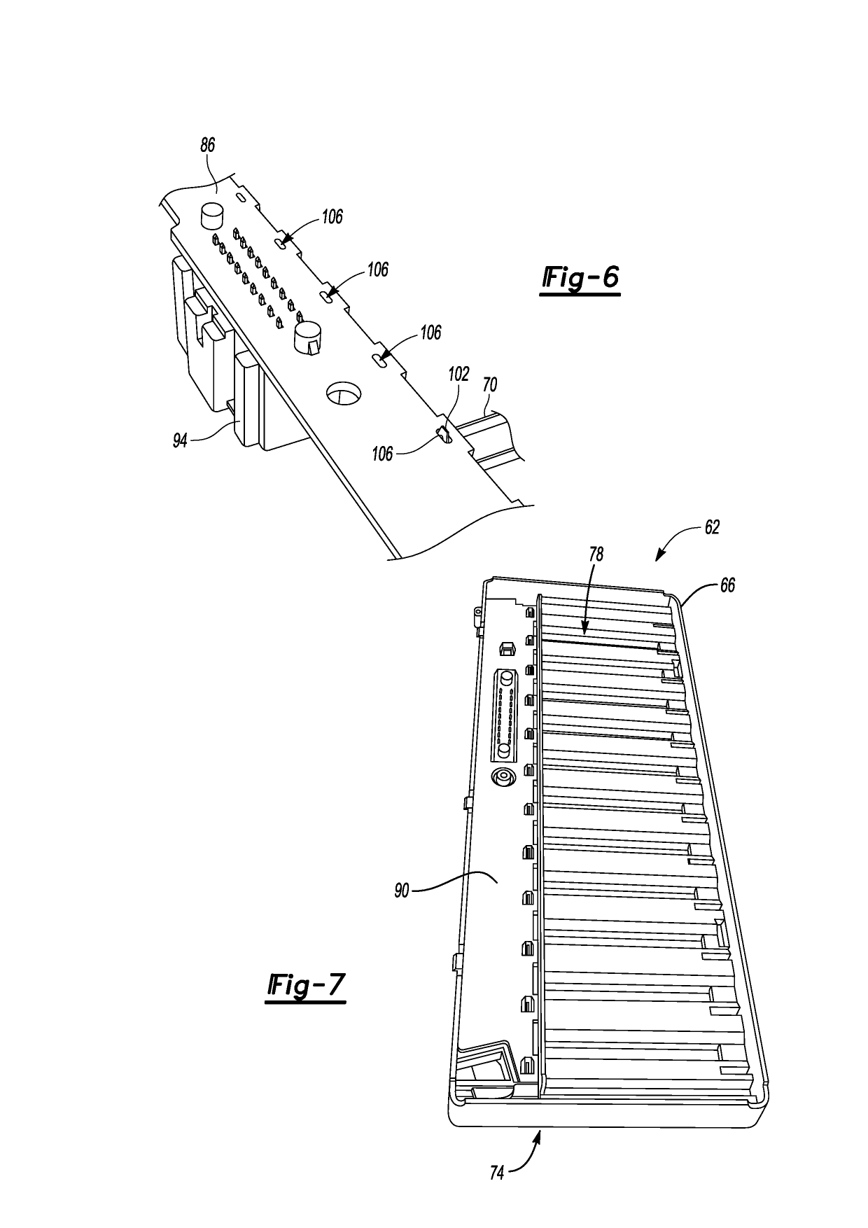

The busbars 70 can include tabs 102 that each extend through a respective opening 106 in the frame 66 to electrically couple the busbars 70 to at least one sense lead trace of the circuit board 86. The frame 66 and some of the busbars 70 are omitted in FIG. 6 to show the connections between the electrical connector 94 and the circuit board 86, and the connection between one of the busbars 70 and the circuit board 86.

With the circuit board 86 disposed within the cavity 98, a polymer-based material is injected or otherwise deposited into the cavity 98 to substantially encapsulate the circuit board 86 within the cavity 98. When cured, the material provides the overmolded covering 90 that secures the circuit board 86 within the cavity 98. The overmolded covering 90 is bonded to the frame 66 after curing.

The exemplary overmolding process is a low-pressure overmolding where the material that will cure to provide the overmolded covering 90 is injected over the circuit board 86 at a pressure that is from 50 to 200 pounds per square inch and a temperature that is nominally 180 degrees Celsius. The low-pressure overmolding process does not utilize a mold that provides core and a cavity. In other examples, the frame 66 with the circuit board 86 could be held within a mold and the overmolded covering 90 at least partially held within a mold. In such an example, the material can be introduced over the circuit board 86 at higher pressures.

Notably, specifying that the overmolded covering 90 is an overmolded covering structurally distinguishes the overmolded covering 90 from other types of covers that are not overmolded, such as a covering that would snap-fit to the frame 66. A person having skill in this art would be able to structurally distinguish the overmolded covering 90 from a covering that is not overmolded. That the overmolded covering 90 is an overmolded covering is a structural distinction differentiating the overmolded covering 90 from covers that are not overmolded.

With the circuit board 86 held against the second side 78 of the frame 66 with the overmolded covering 90, the crossmember assembly 62 can be positioned against the cells 50 of one of the cell stacks 30 with the tab terminals 54 extending through the slots 82. The overmolded covering 90 is then sandwiched between the frame 66 and the cell stacks 30.

The circuit board 86 is operatively coupled to both the busbars 70 and the electrical connector 94. A voltage at the busbars 70, temperatures, etc. can be monitored by operatively coupling a monitoring controller to the electrical connector 94.

The busbars 70 and the electrical connector 94 could be attached to the frame 66 after the circuit board 86 is overmolded to the frame 66 in another example.

The circuit board 86 is a printed circuit board in this example. In other examples, the circuit board 86 could be a rigid circuit board.

Features of the disclosed examples include securing a circuit board utilizing an overmolded covering. This can provide reduced assembly time and part complexity as, among other things, separate fasteners are not required. The overmolded covering can also reduce a likelihood of debris and moisture contacting the circuit board.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a frame;
one or more busbars secured to the frame;
a circuit board; and
an overmolded covering that secures the circuit board to the frame.4

2. The traction battery pack assembly of claim 1, wherein the overmolded covering and the circuit board are disposed with a cavity of the frame.

3. The traction battery pack assembly of claim 1, further comprising a cell stack having a plurality of terminals that each extend through a respective slot in the frame.

4. The traction battery pack assembly of claim 3, wherein the circuit board and the overmolded covering are sandwiched between the cell stack and the frame.

5. The traction battery pack assembly of claim 1, wherein the frame is a polymer-based material.

6. The traction battery pack assembly of claim 1, wherein the busbars are secured to the frame with a plurality of heat stakes.

7. The traction battery pack assembly of claim 1, further comprising at least one sense lead trace of the circuit board, the one or more busbars electrically coupled to the at least one sense lead trace.

8. The traction battery pack assembly of claim 7, wherein the one or more busbars include at least one tab that extends through a slot in the frame to contact the at least one sense lead trace.

9. The traction battery pack assembly of claim 1, wherein the one or more busbars are on a first side of the frame, and the overmolded covering is on an opposite, second side of the frame.

10. The traction battery pack assembly of claim 9, further comprising an electrical connector disposed on the first side of the frame and extending through the frame to operatively connect to the circuit board.

11. The traction battery pack assembly of claim 1, wherein the overmolded covering is an low-pressure overmolded covering.

12. The traction battery pack assembly of claim 1, wherein the circuit board is a printed circuit board.

13. The traction battery pack assembly of claim 1, further comprising one or more wires secured to the frame by the overmolded covering.

14. A traction battery pack assembly, comprising:
a frame;
one or more busbars secured to the frame;
one or more wires; and
an overmolded covering that secures the one or more wires to the frame.

15. A traction battery pack circuit board securing method, comprising:
positioning a circuit board adjacent a frame, the frame configured to hold a plurality of busbars of a traction battery pack; and
overmolding the circuit board with a covering to secure the circuit board relative to the frame.

16. The traction battery pack circuit board securing method of claim 15, wherein the overmolding is a low-pressure overmolding.

17. The traction battery pack circuit board securing method of claim 15, further comprising, during the overmolding, injecting material over the circuit board at a pressure that is from 50 to 200 pounds per square inch.

18. The traction battery pack circuit board securing method of claim 15, further comprising, during the overmolding, injecting material over the circuit board while the circuit board is held within a cavity provided by the frame.

19. The traction battery pack circuit board securing method of claim 15, further comprising a plurality of busbars secured to the frame and extending through the frame to connect to the circuit board.

20. The traction battery pack circuit board securing method of claim 19, wherein the plurality of busbars are secured to a first side of the frame, and the circuit board is overmolded to an opposite, second side of the frame.
